(19) United States
(12) Patent Application Publication
(10) Pub. No.: US 2016/0292844 A1
(43) Pub. Date: Oct. 6, 2016

(54) MEDICAL IMAGE REGISTRATION APPARATUS, MEDICAL IMAGE REGISTRATION METHOD, AND MEDICAL IMAGE REGISTRATION PROGRAM

(71) Applicant: FUJIFILM Corporation, Tokyo (JP)

(72) Inventor: Mikihiko KARUBE, Tokyo (JP)

(73) Assignee: FUJIFILM Corporation, Tokyo (JP)

(21) Appl. No.: 15/075,291

(22) Filed: Mar. 21, 2016

(30) Foreign Application Priority Data
Mar. 31, 2015 (JP) 2015-072133

(51) Int. Cl. G06T 7/00

(52) U.S. Cl. CPC G06T 7/003; G06T 7/0081; G06T 7/0034; G06T 2207/10081; G06T 2207/10088; G06T 2207/20141

(57) ABSTRACT

The medical image registration apparatus includes: a frequency distribution acquisition unit that acquires the frequency distribution of the density value of at least one of first and second medical images obtained by imaging the same subject; a gradation processing unit that performs gradation processing for increasing the frequency distribution in a density range where the number of pixels included in the unit density width is relatively large, of the acquired frequency distribution, and reducing the frequency distribution in a density range where the number of pixels included in the unit density width is relatively small, of the acquired frequency distribution, for at least the one medical image; and a registration processing unit that performs registration processing for matching the anatomical position of the subject included in the first medical image with the anatomical position of the subject included in the second medical image for the first and second medical images.

### CROSS-REFERENCE TO RELATED APPLICATIONS

The present application claims priority under 35 U.S.C. §119 to Japanese Patent Application No. 2015-072133, filed Mar. 31, 2015, all of which are hereby expressly incorporated by reference into the present application.

### BACKGROUND OF THE INVENTION

1. Field of the Invention

The present invention relates to a medical image registration apparatus, a medical image registration method, and a non-transitory computer readable recording medium storing a medical image registration program for performing registration processing between two medical images.

2. Description of the Related Art

When interpreting medical images, the doctor performs a diagnosis by comparing current medical images with medical images captured in the past. In this comparative interpretation, it is necessary to find the corresponding points of medical images to be compared with each other for a region of interest (for example, an organ, a blood vessel, or a tumor). In the current medical images and the past medical images, however, the region of interest is deformed nonlinearly due to temporal changes of the body, the influence of respiration, and the like. Accordingly, there is a problem that a significantly long time is required to find the corresponding points.

In the related art, a new image has also been generated by taking the difference between the current medical image and the past medical image (for example, refer to JP2009-291271A). When calculating such a difference image, if the positional relationship of the subject in the image is different between the current medical image and the past medical image, it is not possible to generate an appropriate difference image.

Therefore, as a process of aligning the positional relationship of the subject in two medical images, a method of performing non-rigid registration processing for nonlinear image transformation has been proposed. In this case, since it is possible to perform highly accurate three-dimensional registration, the burden on the doctor in comparative interpretation is reduced.

For example, WO2013/094152A discloses a registration method of two medical images, which are acquired by imaging the same subject with different types of modalities, so that the spatial position of the subject matches therebetween. WO2013/094152A has proposed a method of changing one medical image so that the subjects of two medical images match each other with high accuracy by reflecting the likelihood of the combination of the density value of a pixel of the other medical image corresponding to the density value of a pixel of one medical image on the evaluation of the degree of similarity.

In addition, U.S. Pat. No. 8,731,334B has proposed a method of generating a joint histogram based on two or more segmented images and performing registration between the two images using the mutual information.

### SUMMARY OF THE INVENTION

For example, in case of performing the registration between a magnetic resonance imaging (Mill) image and a computed tomography (CT) image, the distribution of the density value of the MM image is a distribution as shown in FIG. 8A, and the distribution of the density value of the CT image is a distribution shown in FIG. 8B. FIG. 8A and FIG. 8B show the frequency distribution of the density value generated from tomographic images obtained by imaging the abdomen of a person.

That is, even if the same subject is imaged, the distribution of the density value in the obtained MRI image is different from that in the obtained CT image. Specifically, in the CT image, a plurality of targets (organs, blood vessels, tumors, and the like) to be identified are included in a region of a narrow peak. On the other hand, in the MM image, the density value of one target is gently distributed over the wide range without forming a peak.

Therefore, in case of performing the registration processing between the MRI image and the CT image according to a registration method using, for example, a joint histogram based on the density value distributions that are totally different as described above, there is a problem that the accuracy of registration is reduced since pixels having a predetermined density value do not match each other in a one-to-one manner.

Accordingly, for example, there is a method of reducing the bin width sufficiently when quantizing the density value distribution and dividing a plurality of targets to be identified, which are included in a narrow peak, into a plurality of bins. In this method, however, in the MRI image, the density value of one target distributed over the wide range is divided into a larger number of bins. Then, since the number of pixels corresponding to one density value is further increased, mutual information in the registration method using a joint histogram is reduced. As a result, the accuracy of registration is reduced.

The above problem can be solved by reducing the bin width sufficiently in a region of a narrow peak where a plurality of targets are included and by increasing the bin width in a region where one target is widely distributed. However, since the method of determining the bin width appropriately so as to be changed for each region is complicated, there is a disadvantage that the processing time is increased and the practicability is reduced.

In the above explanation, the problem of medical images of the MRI image and the CT image that are captured by different modalities has been described. However, in a case in which imaging methods are different even if the same modality is used, the same problem occurs since the distribution of the density value is also different. Specifically, in an image captured by the MRI apparatus, the distribution of the density value in T1-weighted imaging is different from that in T2-weighted imaging. For this reason, the same problem occurs. In addition, in the case of images captured by different types of CT apparatuses or in a case in which reconstruction methods are different even if the same CT apparatus is used, the same problem occurs since the distributions of density values in the two images are different. In addition, in the case of an image acquired by imaging using a contrast agent, the same problem occurs since the distribution of the density value changes with a contrast phase.

In view of the above-described situation, it is an object of the invention to provide a medical image registration apparatus, a medical image registration method, and a non-transitory computer readable recording medium storing a medical image registration program capable of performing registration between two medical images with high accuracy without increasing the processing time.

A medical image registration apparatus of the invention includes: a frequency distribution acquisition unit that acquires first and second medical images by imaging the same subject and acquires a frequency distribution of a density value of at least one of the first and second medical images; a gradation processing unit that performs gradation processing for increasing a frequency distribution in a density range where the number of pixels included in a unit density width is relatively large, of the acquired frequency distribution, and reducing a frequency distribution in a density range where the number of pixels included in the unit density width is relatively small, of the acquired frequency distribution, for at least the one medical image; and a registration processing unit that performs registration processing for matching an anatomical position of the subject included in the first medical image with an anatomical position of the subject included in the second medical image for the first and second medical images, at least one of which has been subjected to the gradation processing.

In the medical image registration apparatus of the invention, the gradation processing unit may perform the gradation processing based on a cumulative histogram of the frequency distribution.

In the medical image registration apparatus of the invention, the gradation processing unit may perform the gradation processing for linearly increasing the cumulative histogram.

In the medical image registration apparatus of the invention, the gradation processing unit may perform the gradation processing for matching a cumulative histogram of at least one of the first and second medical images with a cumulative histogram set in advance.

In the medical image registration apparatus of the invention, the gradation processing unit may perform the gradation processing for bringing a cumulative histogram of a frequency distribution of a density value of the first medical image and a cumulative histogram of a frequency distribution of a density value of the second medical image close to each other.

The medical image registration apparatus of the invention may further include a subject region extraction unit that extracts a region of the subject from the first and second medical images. The frequency distribution acquisition unit may acquire a frequency distribution of a density value of a region of the subject of at least one of the first and second medical images. The gradation processing unit may perform the gradation processing for the region of the subject based on the frequency distribution of the density value of the region of the subject. The registration processing unit may perform the registration processing between the region of the subject in the first medical image and the region of the subject in the second medical image.

In the medical image registration apparatus of the invention, it is preferable that the first and second medical images are images captured by different modalities.

In the medical image registration apparatus of the invention, it is preferable that the first medical image is an image captured by a CT apparatus and the second medical image is an image captured by an MM apparatus.

In the medical image registration apparatus of the invention, it is preferable that the first and second medical images are MRI images captured by using different imaging methods.

In the medical image registration apparatus of the invention, it is preferable that the first and second medical images are CT images captured by different types of CT apparatuses.

A medical image registration method of the invention includes: acquiring a frequency distribution of a density value of at least one of first and second medical images obtained by imaging the same subject; performing gradation processing for increasing a frequency distribution in a density range where the number of pixels included in a unit density width is relatively large, of the acquired frequency distribution, and reducing a frequency distribution in a density range where the number of pixels included in the unit density width is relatively small, of the acquired frequency distribution, for at least the one medical image; and performing registration processing for matching an anatomical position of the subject included in the first medical image with an anatomical position of the subject included in the second medical image for the first and second medical images, at least one of which has been subjected to the gradation processing.

A non-transitory computer readable recording medium storing a medical image registration program of the invention causes a computer to function as: a frequency distribution acquisition unit that acquires first and second medical images by imaging the same subject and acquires a frequency distribution of a density value of at least one of the first and second medical images; a gradation processing unit that performs gradation processing for increasing a frequency distribution in a density range where the number of pixels included in a unit density width is relatively large, of the acquired frequency distribution, and reducing a frequency distribution in a density range where the number of pixels included in the unit density width is relatively small, of the acquired frequency distribution, for at least the one medical image; and a registration processing unit that performs registration processing for matching an anatomical position of the subject included in the first medical image with an anatomical position of the subject included in the second medical image for the first and second medical images, at least one of which has been subjected to the gradation processing.

According to the medical image registration apparatus, the medical image registration method, and the medical image registration program of the invention, the frequency distribution of the density value of at least one of the first and second medical images obtained by imaging the same subject is acquired, and the gradation processing for increasing the frequency distribution in a density range where the number of pixels included in the unit density width is relatively large, of the acquired frequency distribution, and reducing the frequency distribution in a density range where the number of pixels included in the unit density width is relatively small, of the acquired frequency distribution, is performed for at least the one medical image. By the gradation processing, the probability of the presence of each density value can fall within a predetermined range.

In addition, the registration processing is performed for the first and second medical images, at least one of which has been subjected to gradation processing. Accordingly, for example, even if registration between a CT image having a density value distribution of a narrow peak in which it is difficult to identify a plurality of targets and an MRI image in which the density value of one target is gently distributed over the wide range without forming a peak is performed, that is, even if registration between two images having different density value distributions is performed, it is possible to perform the registration accurately without increasing the processing time.

### BRIEF DESCRIPTION OF THE DRAWINGS

FIG. 1 is a block diagram showing the schematic configuration of a medical image display system using an embodiment of a medical image registration apparatus of the invention.

FIG. 2 is a schematic diagram of the frequency distribution.

FIG. 3 is a schematic diagram showing the frequency distribution before gradation processing and the frequency distribution after gradation processing.

FIGS. 4A and 4B are schematic diagrams showing a cumulative histogram before gradation processing and a cumulative histogram after gradation processing.

FIG. 5 is a flowchart illustrating the operation of the medical image display system using an embodiment of the medical image registration apparatus of the invention.

FIG. 6 is a diagram showing examples of a CT image CT1 and an MRI image MR2 before registration processing, the MM image MR2 after gradation processing, and the CT image CT2 after performing registration processing using the MM image MR2 after gradation processing.

FIG. 7 is a block diagram showing the schematic configuration of a medical image display system using another embodiment of the medical image registration apparatus of the invention.

FIG. 8A and 8B are diagrams showing the distribution of the density value of an MM image and the distribution of the density value of a CT image.

### DESCRIPTION OF THE PREFERRED EMBODIMENTS

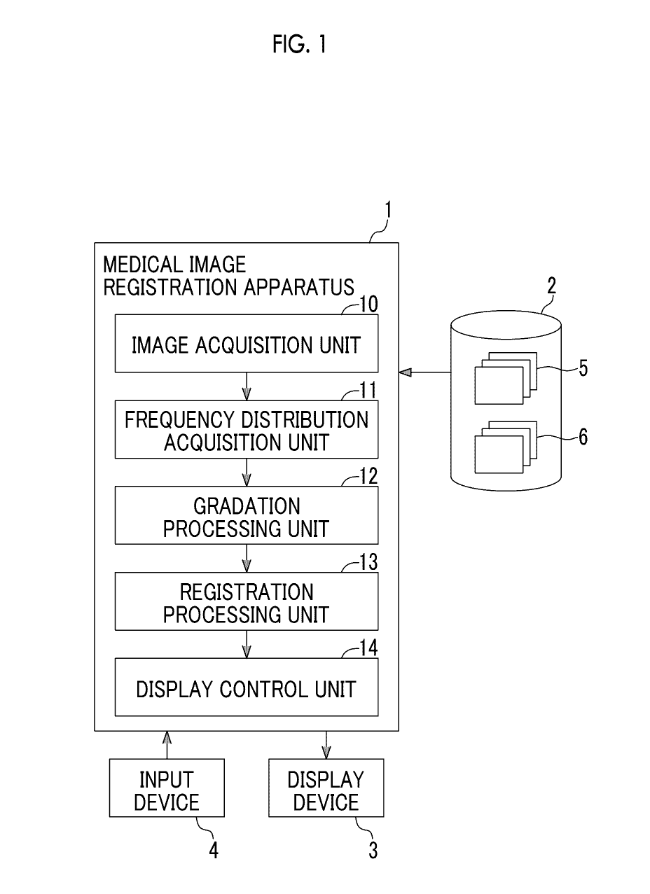

Hereinafter, a medical image display system using an embodiment of a medical image registration apparatus, a medical image registration method, and a medical image registration program of the invention will be described in detail with reference to the accompanying diagrams. FIG. 1 is a block diagram showing the schematic configuration of the medical image display system of the present embodiment.

As shown in FIG. 1, the medical image display system of the present embodiment includes a medical image registration apparatus 1, a medical image storage server 2, a display device 3, and an input device 4.

The medical image registration apparatus 1 includes an image acquisition unit 10, a frequency distribution acquisition unit 11, a gradation processing unit 12, a registration processing unit 13, and a display control unit 14.

The medical image registration apparatus 1 is a computer configured to include a central processing unit (CPU), a semiconductor memory, and a storage device such as a hard disk or a solid state drive (SSD). The medical image registration program of the present embodiment is installed in the storage device, and is executed by the central processing unit so that the image acquisition unit 10, the frequency distribution acquisition unit 11, the gradation processing unit 12, the registration processing unit 13, and the display control unit 14 function.

The image acquisition unit 10 reads and acquires medical images 5 and 6 stored in the medical image storage server 2. A plurality of medical images captured by imaging the same subject are stored in the medical image storage server 2. In the present embodiment, it is assumed that the first medical image 5 obtained by imaging the same subject using a CT apparatus and the second medical image 6 obtained by imaging the same subject using an MRI apparatus are stored. For example, the first and second medical images 5 and 6 may be sectional images of the subject, or may be three-dimensional images. In addition, the first and second medical images 5 and 6 are not limited to the CT image and the MRI image, and may be images captured by a positron emission tomography (PET) apparatus, or may be images captured by a single photon emission computed tomography (SPECT) apparatus, or may be ultrasonic images.

In the medical image storage server 2, the identification information and the medical image of the subject are stored so as to match each other. By setting and inputting the identification information of the subject by the user using the input device 4, the image acquisition unit 10 reads and acquires the first and second medical images 5 and 6 corresponding to the input identification information from the medical image storage server 2.

In the present embodiment, as described above, the image captured by the CT is acquired as the first medical image 5, and the image captured by the MRI is acquired as the second medical image 6. However, the first and second medical images 5 and 6 do not necessarily be images captured by different types of modalities. For example, images obtained by imaging the same subject using different types of CT apparatuses may be the first and second medical images 5 and 6, or images obtained by imaging the same subject using different types of MRI apparatuses may be the first and second medical images 5 and 6. In addition, the first and second medical images 5 and 6 may be images captured by using different imaging methods (for example, T1-weighted imaging, T2-weighted imaging, and a fat suppression method) using the same MRI apparatus, or may be images captured by the same CT apparatus, or may be images reconstructed by using different reconstruction methods.

The frequency distribution acquisition unit 11 receives the first and second medical images 5 and 6 that have been acquired by the image acquisition unit 10, and acquires the frequency distribution of the density value of at least one of these medical images. In the present embodiment, since the gradation processing unit 12 performs gradation processing based on the frequency distribution for the second medical image 6 captured by the MM apparatus, it is assumed that the frequency distribution of the second medical image 6 is acquired. In case of performing gradation processing for the first medical image 5 captured by the CT apparatus, the gradation processing unit 12 may also the acquire frequency distribution for the first medical image 5.

It is assumed that the gradation processing unit 12 performs gradation processing for increasing the frequency distribution in a density range, in which the number of pixels included in the unit density width is relatively large, and reducing the frequency distribution in a density range, in which the number of pixels included in the unit density width is relatively small, on the frequency distribution acquired by the frequency distribution acquisition unit 11.

Here, the unit density width is a predetermined partial density width that is narrower than the width of the entire density range of the density value of a medical image. For example, the unit density width can be set to the width of 5% of the width of the entire density range. In addition, the unit density width may be set in advance according to the type of a medical image, for example. Specifically, different density widths may be set as the unit density width of a CT image and the unit density width of an MM image.

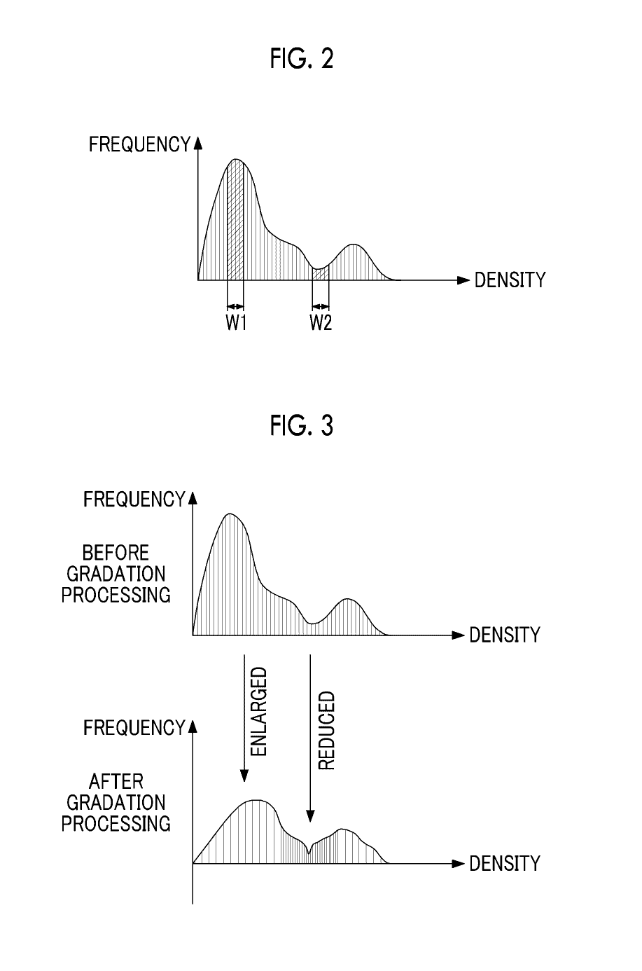

In addition, the number of pixels included in the unit density width is the number of pixels included in the unit density width having each density value at its center on the frequency distribution. FIG. 2 schematically shows the frequency distribution. In FIG. 2, portions indicated by oblique lines are examples of the number of pixels (frequency) included in unit density widths W1 and W2.

In addition, “the number of pixels included in the unit density width is relatively large” refers to “the ratio of the number of pixels included in the unit density width to the total number of pixels included in a medical image is large”. For example, the number of pixels included in the unit density width is assumed to be relatively large in a case in which the ratio of the number of pixels included in the unit density width to the total number of pixels is equal to or greater than a predetermined value, and the number of pixels included in the unit density width is assumed to be relatively small in a case in which the ratio of the number of pixels included in the unit density width to the total number of pixels is less than the predetermined value. In addition, in a case in which the ratio of the number of pixels included in the unit density width to the total number of pixels is arranged in descending order, the number of pixels included in the unit density width may be assumed to be relatively large in the case of a ratio of higher order, and the number of pixels included in the unit density width may be assumed to be relatively small in the case of a ratio of lower order. In addition, the characteristics of the shape of the frequency distribution may be used, and the number of pixels included in the unit density width may be assumed to be relatively large in a case in which the inclination of the frequency distribution in the unit density width is larger than a predetermined value and the number of pixels included in the unit density width may be assumed to be relatively large in a case in which the inclination of the frequency distribution in the unit density width is smaller than the predetermined value.

In the example shown in FIG. 2, it can be said that the number of pixels included in the unit density width W1 on the left side is relatively large and the number of pixels included in the unit density width W2 on the right side is relatively small.

As described above, the gradation processing unit 12 performs gradation processing for increasing the frequency distribution in a density range, in which the number of pixels included in the unit density width is relatively large, and reducing the frequency distribution in a density range, in which the number of pixels included in the unit density width is relatively small, on the medical image. FIG. 3 is a schematic diagram showing the frequency distribution before gradation processing and the frequency distribution after gradation processing.

Specifically, in the present embodiment, equalization processing is performed as the gradation processing. The equalization processing is a process of converting the density value of each pixel so that the cumulative histogram generated from the frequency distribution increases linearly. That is, the equalization processing is nonlinear gradation conversion processing.

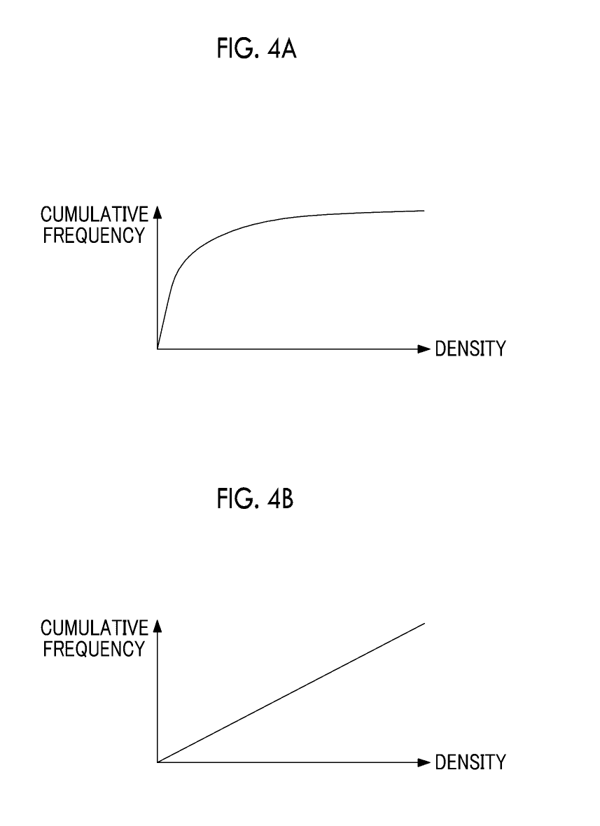

Specifically, for example, the density value of each pixel is converted so that the cumulative histogram shown in FIG. 4A becomes a cumulative histogram that increases linearly shown in FIG. 4B. By performing the equalization processing, the probability of the presence of each density value can fall within a predetermined range. Conversely, for the conversion to the cumulative histogram that increases linearly shown in FIG. 4B, it is necessary to perform processing for increasing the frequency distribution in a density range, in which the number of pixels included in the unit density width is relatively large, and reducing the frequency distribution in a density range, in which the number of pixels included in the unit density width is relatively small.

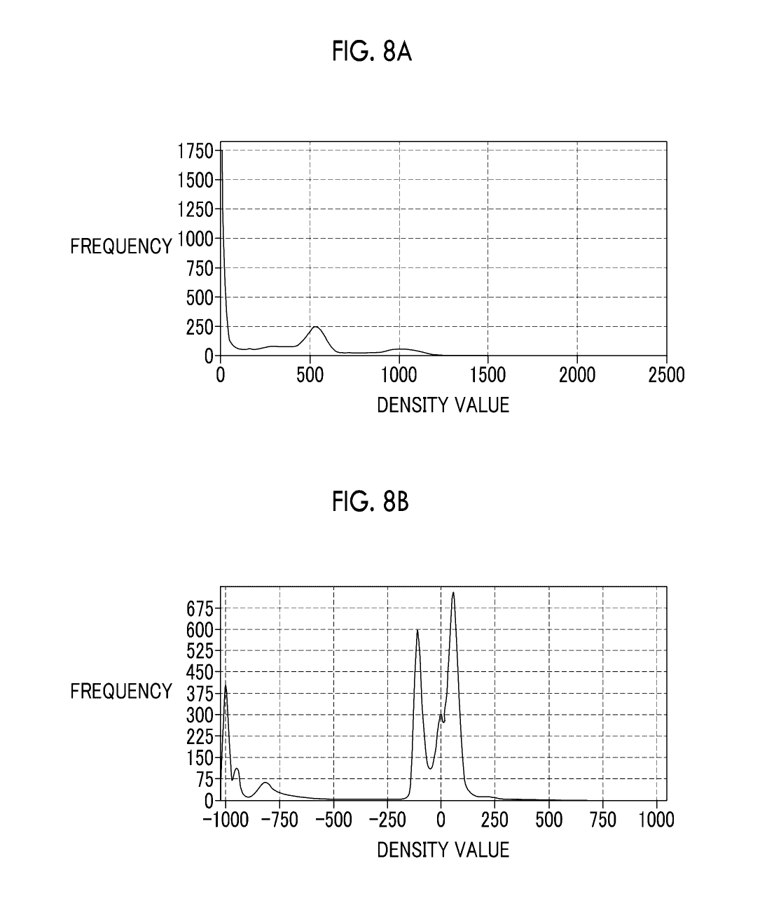

In the present embodiment, the frequency distribution of the second medical image 6 captured by the MRI apparatus is acquired, and the gradation processing unit 12 performs equalization processing on the second medical image 6. In the density value distribution of a typical MM image, a sharp peak appears in the region of the low density value as shown in FIG. 8A and other pixel values are distributed over the wide range in many cases. However, by performing the equalization processing, the probability of the presence of each density value can fall within a predetermined range as described above. In addition, the frequency distribution of the first medical image 5 captured by the CT apparatus as described above may be acquired, and the gradation processing unit 12 may perform equalization processing on the first medical image 5.

The registration processing unit 13 performs registration processing for matching the anatomical position of the subject included in the first medical image 5 with the anatomical position of the subject included in the second medical image 6 for the first and second medical images 5 and 6, at least one of which has been subjected to gradation processing. The registration processing unit 13 of the present embodiment performs registration between the first medical image 5 (CT image) and the second medical image 6 (MRI image) that has been subjected to gradation processing as described above.

Specifically, the registration processing unit 13 performs non-rigid registration processing as the registration processing. As the non-rigid registration processing, a method using a joint histogram can be used. Specifically, a joint histogram is generated from the first medical image 5 and the second medical image 6 that has been subjected to gradation processing, and non-rigid registration processing using the mutual information is performed. In addition, for the non-rigid registration processing using the mutual information based on the joint histogram, it is possible to use methods that have already been known, such as the method disclosed in U.S. Pat. No. 8,731,334B.

Specifically, a plurality of feature points are first disposed on the first medical image 5. Then, an image of a predetermined range including the feature points is cut out as a template, and the most similar portion on the second medical image 6 is found. For the evaluation of the degree of similarity, the mutual information described above is used. The amount of movement of each feature point is determined by performing the same processing for each feature point, and the amount of movement of each pixel (voxel) other than the feature point is determined by interpolation according to the distance from the feature point.

As another method, the amount of movement of each of a plurality of feature points disposed on the first medical image 5 as described above is variously changed, and the degree of similarity between the first medical image 5 after the change and the second medical image 6 is calculated. The amount of movement of the feature point when the degree of similarity is the highest is determined as the amount of registration. For the evaluation of the degree of similarity, the mutual information described above is used. The amount of movement of each pixel (voxel) other than the feature point is determined by interpolation according to the distance from the feature point.

The display control unit 14 displays the first and second medical images 5 and 6, which have been subjected to the registration processing by the registration processing unit 13, on the display device 3. In addition, the display control unit 14 may display thumbnail images or the like of a plurality of medical images before registration processing on the display device 3, so that the first and second medical images 5 and 6 to be subjected to registration processing are selectable from the plurality of thumbnail images.

The display device 3 includes a display device, such as a liquid crystal display, and displays the first and second medical images 5 and 6 after registration processing and thumbnail images or the like of a plurality of medical images before registration processing as described above.

The input device 4 receives various setting inputs by the user, and includes an input device, such as a keyboard or a mouse. Specifically, the input device 4 receives the selection of two medical images to be subjected to registration processing.

The selection of two medical images to be subjected to registration processing does not necessarily need to be performed by the user, and two medical images to be subjected to registration processing may be automatically selected. For example, information of imaging date and time may be added to each medical image, and a plurality of medical images of the same imaging date and time may be automatically selected to perform the above-described gradation processing and registration processing. In addition, a medical image captured this time and a past medical image captured most recently may be automatically selected. In addition, information of an imaging part may be added to each medical image, and a plurality of medical images of the same imaging part may be automatically selected to perform the above-described gradation processing and registration processing.

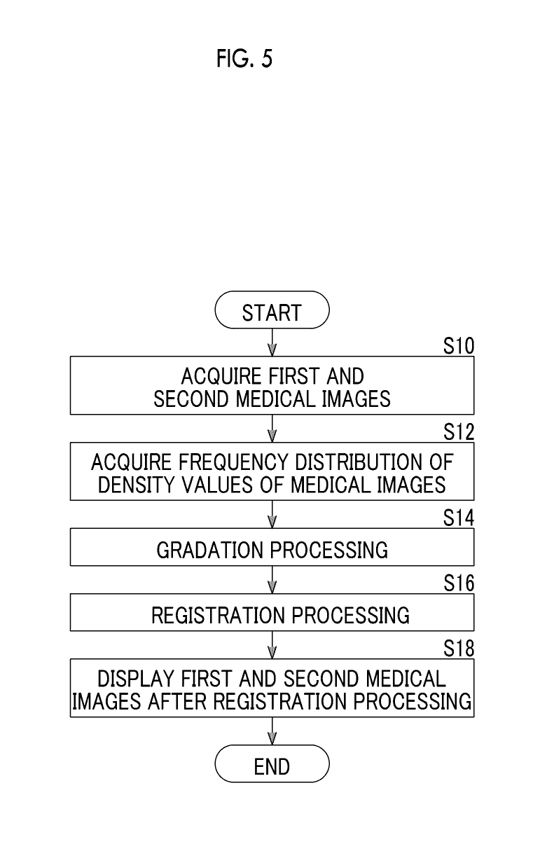

Next, the operation of the medical image display system of the present embodiment will be described with reference to the flowchart shown in FIG. 5.

First, the image acquisition unit 10 acquires the first and second medical images 5 and 6, which are registration processing targets, based on the setting input of the identification information of the subject by the user (S10).

The first and second medical images 5 and 6 acquired by the image acquisition unit 10 are transmitted to the frequency distribution acquisition unit 11, and the frequency distribution acquisition unit 11 acquires the frequency distribution of the density value of at least one of the first and second medical images 5 and 6 (S12).

Then, the gradation processing unit 12 performs gradation processing on at least one of the first and second medical images 5 and 6 based on the frequency distribution acquired by the frequency distribution acquisition unit 11 (S14). Specifically, in the present embodiment, equalization processing is performed as the gradation processing.

Then, the first and second medical images 5 and 6, at least one of which has been subjected to gradation processing by the gradation processing unit 12, are transmitted to the registration processing unit 13, and the registration processing unit 13 performs registration processing between the first and second medical images 5 and 6, at least one of which has been subjected to gradation processing (S16). Specifically in the present embodiment, non-rigid registration processing is performed as the registration processing.

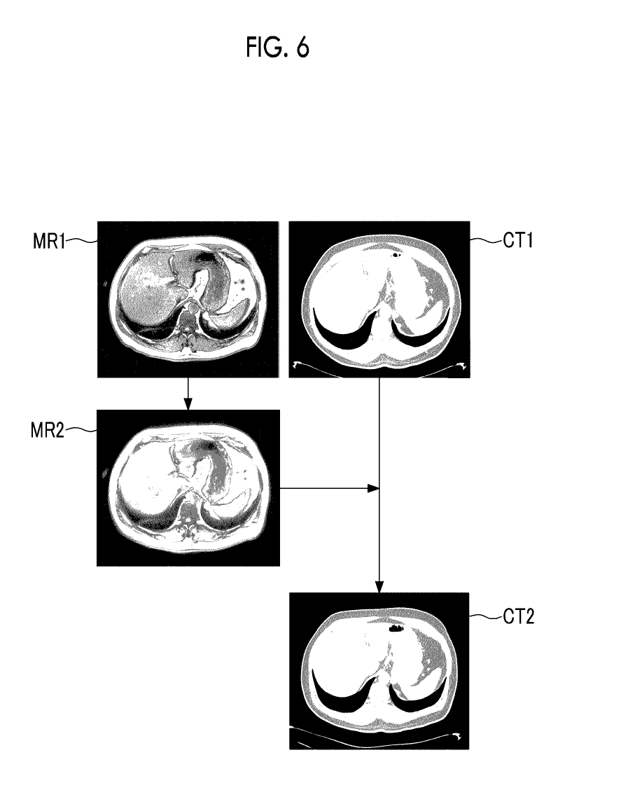

Then, the first and second medical images 5 and 6 after the registration processing are transmitted to the display control unit 14, and the display control unit 14 displays these medical images on the display device 3 (S18). FIG. 6 is a diagram showing examples of a CT image CT1 (first medical image 5) and an MRI image MR1 (second medical image 6) before registration processing, an MRI image MR2 after gradation processing, and a CT image CT2 after performing registration processing using the MM image MR2 after gradation processing.

According to the medical image display system of the embodiment described above, the frequency distribution of the density value of at least one of the first and second medical images 5 and 6 obtained by imaging the same subject is acquired, and the gradation processing for increasing the frequency distribution in a density range where the number of pixels included in the unit density width is relatively large, of the acquired frequency distribution, and reducing the frequency distribution in a density range where the number of pixels included in the unit density width is relatively small, of the acquired frequency distribution, is performed for at least the one medical image. By the gradation processing, the probability of the presence of each density value can fall within a predetermined range.

In addition, the registration processing is performed for the first and second medical images 5 and 6, at least one of which has been subjected to gradation processing. Accordingly, for example, even if registration between a CT image having a density value distribution of a narrow peak in which it is difficult to identify a plurality of targets and an MRI image in which the density value of one target is gently distributed over the wide range without forming a peak is performed, that is, even if registration between two images having different density value distributions is performed, it is possible to perform the registration accurately without increasing the processing time.

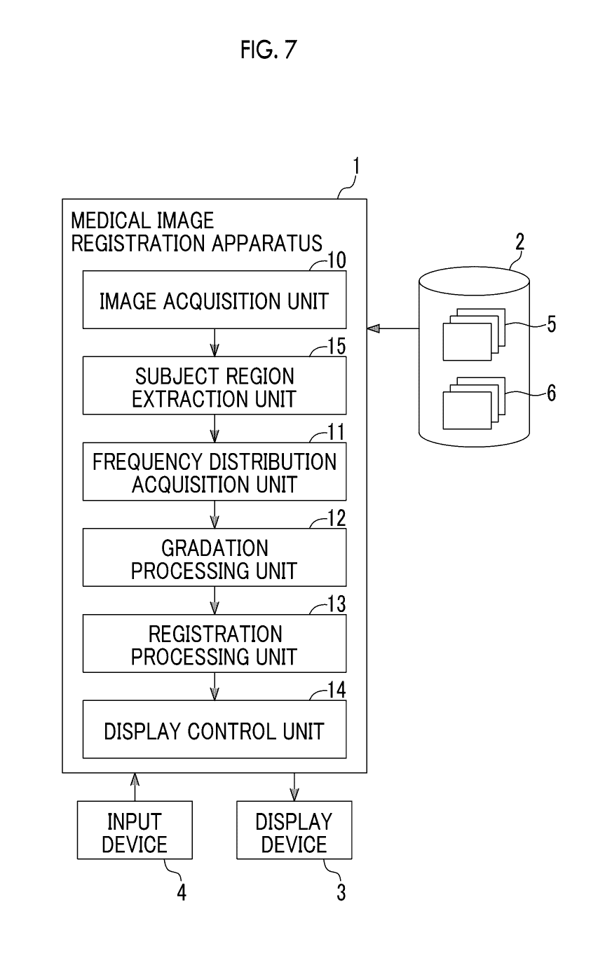

In the medical image display system of the embodiment described above, as shown in FIG. 7, a subject region extraction unit 15 that extracts a region of the subject from the first and second medical images 5 and 6 may be further provided. In addition, the frequency distribution acquisition unit 11 may acquire the frequency distribution of the density value of a region of the subject of at least one of the first and second medical images 5 and 6, the gradation processing unit 12 may perform gradation processing for the region of the subject based on the frequency distribution of the density value of the region of the subject, and the registration processing unit 13 may perform registration processing between the region of the subject in the first medical image 5 and the region of the subject in the second medical image 6.

In a case in which each of the first and second medical images 5 and 6 is, for example, an axial sectional image of the chest or the abdomen of a person, the subject region extraction unit 15 can extract a body region included in the tomographic image as a region of the subject. Alternatively, the subject region extraction unit 15 may extract, as a region of the subject, a region of an organ, such as the heart or the liver that is not the entire body region but a region of interest, or a region of a lesion, such as a tumor. Alternatively, in a case in which each of the first and second medical images 5 and 6 is a three-dimensional image, a region of an organ, such as the heart or the liver, or a region of a lesion, such as a tumor, may be extracted from the three-dimensional image as a region of the subject.

In the embodiment described above, the equalization processing using a cumulative histogram is performed as gradation processing. However, the cumulative histogram does not necessarily need to be used. For example, density conversion processing for fixing the number of pixels included in the unit density width for each density value may be performed. Instead of fixing the number of pixels included in the unit density width for each density value, a distribution obtained in advance by learning or the like may be used. In addition, the density conversion amount of the pixel of each density value may be set according to the combination of the first and second medical images 5 and 6. Specifically, the density conversion amount of each density value in case of performing the registration between a CT image and an Mill image may be set, or the density conversion amount of each density value in case of performing the registration between Mill images captured by using different imaging methods may be set.

As the gradation processing, the gradation processing unit 12 may perform density conversion processing for matching with a cumulative histogram, which is set in advance, for at least one of the first and second medical images 5 and 6. Specifically, for example, a function indicating the cumulative histogram may be set in advance, and density conversion processing for matching the cumulative histogram of at least one of the first and second medical images 5 and 6 with the function may be performed. In addition, y =x^{a} may be set as a function, and the value of a may be changed according to the type of a medical image to be subjected to registration processing or the combination of medical images. Here, x indicates a density value, and y indicates a value obtained by cumulatively adding the frequency of each density value equal to or less than the density value x. The combination of medical images to be subjected to registration processing is the above-described combination of a CT image and an MRI image and the above-described combination of Mill images captured by using different imaging methods, for example.

As the gradation processing, the gradation processing unit 12 may perform density conversion processing for bringing the cumulative histogram of the frequency distribution of the density value of the first medical image 5 and the cumulative histogram of the frequency distribution of the density value of the second medical image 6 close to each other.

The gradation processing unit 12 may perform gradation processing using a feature of the shape of the frequency distribution, or may perform density conversion processing for making the inclination of the frequency distribution in the unit density width fall within a predetermined range.

What is claimed is:

1. A medical image registration apparatus, comprising:
a frequency distribution acquisition unit that acquires first and second medical images by imaging the same subject and acquires a frequency distribution of a density value of at least one of the first and second medical images;
a gradation processing unit that performs gradation processing for increasing a frequency distribution in a density range where the number of pixels included in a unit density width is relatively large, of the acquired frequency distribution, and reducing a frequency distribution in a density range where the number of pixels included in the unit density width is relatively small, of the acquired frequency distribution, for at least the one medical image; and
a registration processing unit that performs registration processing for matching an anatomical position of the subject included in the first medical image with an anatomical position of the subject included in the second medical image for the first and second medical images, at least one of which has been subjected to the gradation processing.

2. The medical image registration apparatus according to claim 1,
wherein the gradation processing unit performs the gradation processing based on a cumulative histogram of the frequency distribution.

3. The medical image registration apparatus according to claim 2,
wherein the gradation processing unit performs the gradation processing for linearly increasing the cumulative histogram.

4. The medical image registration apparatus according to claim 2,
wherein the gradation processing unit performs the gradation processing for matching a cumulative histogram of at least one of the first and second medical images with a cumulative histogram set in advance.

5. The medical image registration apparatus according to claim 3,
wherein the gradation processing unit performs the gradation processing for matching a cumulative histogram of at least one of the first and second medical images with a cumulative histogram set in advance.

6. The medical image registration apparatus according to claim 2,
wherein the gradation processing unit performs the gradation processing for bringing a cumulative histogram of a frequency distribution of a density value of the first medical image and a cumulative histogram of a frequency distribution of a density value of the second medical image close to each other.

7. The medical image registration apparatus according to claim 1, further comprising:
a subject region extraction unit that extracts a region of the subject from the first and second medical images,
wherein the frequency distribution acquisition unit acquires a frequency distribution of a density value of a region of the subject of at least one of the first and second medical images,
the gradation processing unit performs the gradation processing for the region of the subject based on the frequency distribution of the density value of the region of the subject, and
the registration processing unit performs the registration processing between the region of the subject in the first medical image and the region of the subject in the second medical image.

8. The medical image registration apparatus according to claim 2, further comprising:
a subject region extraction unit that extracts a region of the subject from the first and second medical images,
wherein the frequency distribution acquisition unit acquires a frequency distribution of a density value of a region of the subject of at least one of the first and second medical images,
the gradation processing unit performs the gradation processing for the region of the subject based on the frequency distribution of the density value of the region of the subject, and
the registration processing unit performs the registration processing between the region of the subject in the first medical image and the region of the subject in the second medical image.

9. The medical image registration apparatus according to claim 3, further comprising:
a subject region extraction unit that extracts a region of the subject from the first and second medical images,
wherein the frequency distribution acquisition unit acquires a frequency distribution of a density value of a region of the subject of at least one of the first and second medical images,
the gradation processing unit performs the gradation processing for the region of the subject based on the frequency distribution of the density value of the region of the subject, and
the registration processing unit performs the registration processing between the region of the subject in the first medical image and the region of the subject in the second medical image.

10. The medical image registration apparatus according to claim 4, further comprising:
a subject region extraction unit that extracts a region of the subject from the first and second medical images,
wherein the frequency distribution acquisition unit acquires a frequency distribution of a density value of a region of the subject of at least one of the first and second medical images,
the gradation processing unit performs the gradation processing for the region of the subject based on the frequency distribution of the density value of the region of the subject, and
the registration processing unit performs the registration processing between the region of the subject in the first medical image and the region of the subject in the second medical image.

11. The medical image registration apparatus according to claim 5, further comprising:
a subject region extraction unit that extracts a region of the subject from the first and second medical images,
wherein the frequency distribution acquisition unit acquires a frequency distribution of a density value of a region of the subject of at least one of the first and second medical images,
the gradation processing unit performs the gradation processing for the region of the subject based on the frequency distribution of the density value of the region of the subject, and
the registration processing unit performs the registration processing between the region of the subject in the first medical image and the region of the subject in the second medical image.

12. The medical image registration apparatus according to claim 1,
wherein the first and second medical images are images captured by different modalities.

13. The medical image registration apparatus according to claim 2,
wherein the first and second medical images are images captured by different modalities.

14. The medical image registration apparatus according to claim 3,
wherein the first and second medical images are images captured by different modalities.

15. The medical image registration apparatus according to claim 4,
wherein the first and second medical images are images captured by different modalities.

16. The medical image registration apparatus according to claim 12,
wherein the first medical image is an image captured by a computed tomography (CT) apparatus, and the second medical image is an image captured by a magnetic resonance imaging (MRI) apparatus.

17. The medical image registration apparatus according to claim 1,
wherein the first and second medical images are MM images captured by using different imaging methods.

18. The medical image registration apparatus according to claim 1,
wherein the first and second medical images are CT images captured by different types of CT apparatuses.

19. A medical image registration method using the medical image registration apparatus according to claim 1, comprising:
acquiring a frequency distribution of a density value of at least one of first and second medical images obtained by imaging the same subject;
performing gradation processing for increasing a frequency distribution in a density range where the number of pixels included in a unit density width is relatively large, of the acquired frequency distribution, and reducing a frequency distribution in a density range where the number of pixels included in the unit density width is relatively small, of the acquired frequency distribution, for at least the one medical image; and
performing registration processing for matching an anatomical position of the subject included in the first medical image with an anatomical position of the subject included in the second medical image for the first and second medical images, at least one of which has been subjected to the gradation processing.

20. A non-transitory computer readable recording medium storing a medical image registration program causing a computer to function as:
a frequency distribution acquisition unit that acquires first and second medical images by imaging the same subject and acquires a frequency distribution of a density value of at least one of the first and second medical images;
a gradation processing unit that performs gradation processing for increasing a frequency distribution in a density range where the number of pixels included in a unit density width is relatively large, of the acquired frequency distribution, and reducing a frequency distribution in a density range where the number of pixels included in the unit density width is relatively small, of the acquired frequency distribution, for at least the one medical image; and
a registration processing unit that performs registration processing for matching an anatomical position of the subject included in the first medical image with an anatomical position of the subject included in the second medical image for the first and second medical images, at least one of which has been subjected to the gradation processing.
